(19) United States
(12) Patent Application Publication
(10) Pub. No.: US 2020/0274719 A1
(43) Pub. Date: Aug. 27, 2020

(54) GENERATING TRUST FOR DEVICES

(71) Applicant: Arm Limited, Cambridge (GB)

(72) Inventors: Yongbeom Pak, Oulu (FI); Mikko Johannes Saarnivala, Oulu (FI)

(21) Appl. No.: 16/791,545

(22) Filed: Feb. 14, 2020

(30) Foreign Application Priority Data
Feb. 21, 2019 (GB) 1902374.6

(51) Int. Cl. H04L 9/32; H04L 12/66; G06F 9/4401; H04L 29/06

(52) U.S. Cl. CPC H04L 9/3265; H04L 12/66; H04L 9/3268; H04L 69/08; G06F 9/4416

(57) ABSTRACT

A gateway apparatus for registering a device with a resource server, the GW apparatus comprising a GW server, the GW apparatus to: receive gateway credential data having a verifiable chain of trust to a root authority to authenticate with the resource server; receive, at the GW server, GW server credential data comprising a trust anchor to verify whether device credential data presented by the device has a chain of trust to the root authority and a GW server certificate comprising a verifiable chain of trust to the root authority; authenticate, at the GW server, the device using the GW server credential data; and in response to successful authentication of the device, register, using the GW server, the device with the resource server.

### RELATED APPLICATION

The present application claims priority to Application No. GB 1902374.6 filed Feb. 21, 2019, which is hereby incorporated herein in its entirety by reference.

The present techniques generally relate to a building trust between different devices in a network and/or across different networks. In particular, the present techniques generally relate to building trust to enable (Internet Protocol) IP-enabled endpoint devices to access one or more remote resources.

The Internet of Things (IoT) encompasses devices and networks that are IP-enabled and Internet-connected, along with the Internet services monitoring and controlling those devices. Such IP-enabled devices connected to the internet may be termed data processing devices, end nodes, remote devices or Internet of Things (IoT) devices and include sensors, machines, active positioning tags, radio-frequency identification (RFID) readers and building automation equipment to name but a few. Such an IP-enabled device is hereafter referred to as “device.”

Devices in the IoT may generally, but not necessarily, be resource-limited embedded devices, often battery powered and connected by low-power, low-bandwidth wireless networks to the Internet.

The present applicant has recognized the need for improving registration of device(s) and resources (e.g. a resource server such as an LwM2M server).

According to a first technique there is provided a gateway (GW) apparatus for registering a device with a resource server, the GW apparatus comprising a GW server, the GW apparatus to: receive gateway credential data having a verifiable chain of trust to a root authority to authenticate with the resource server; receive, at the GW server, GW server credential data comprising a trust anchor to verify whether device credential data presented by the device has a chain of trust to the root authority and a GW server certificate comprising a verifiable chain of trust to the root authority;

authenticate, at the GW server, the device using the GW server credential data; and in response to successful authentication of the device, register, using the GW server, the device with the resource server.

According to a further technique there is provided a method of registering a device at a resource server, the method comprising: receiving, at a gateway (GW) apparatus, GW credential data having a verifiable chain of trust to a root authority to authenticate with the resource server; receiving, at the GW apparatus, GW server credential data comprising a trust anchor to verify whether device credential data presented by the device has a chain of trust to the root authority and a GW server certificate comprising a verifiable chain of trust to the root authority; authenticating, at the GW apparatus, the device using the GW server credential data; registering, using the GW apparatus, the device with the resource server in response to successful authentication of the device.

According to a further technique there is provided a system comprising: a device to store device credential data; a resource server; a gateway (GW) apparatus to store: gateway credential data comprising a verifiable chain of trust to a root authority to authenticate with the resource server; the gateway apparatus having a GW server to store: GW server credential data comprising a trust anchor to verify that device credential data presented by the device has a chain of trust to the root authority and a GW server certificate comprising a verifiable chain of trust to the root authority, wherein the GW server is to authenticate the device using the GW server credential data; and wherein the GW server is to register the device with the resource server when the device is authenticated.

According to a further technique there is provided a gateway apparatus comprising an intermediate certificate authority to generate credential data having a chain of trust to a root authority, the credential data to be made available to a device to enable the device to authenticate with the gateway apparatus or a further peer gateway by presenting the credential data thereto.

The techniques are diagrammatically illustrated, by way of example, in the accompanying drawings, in which:

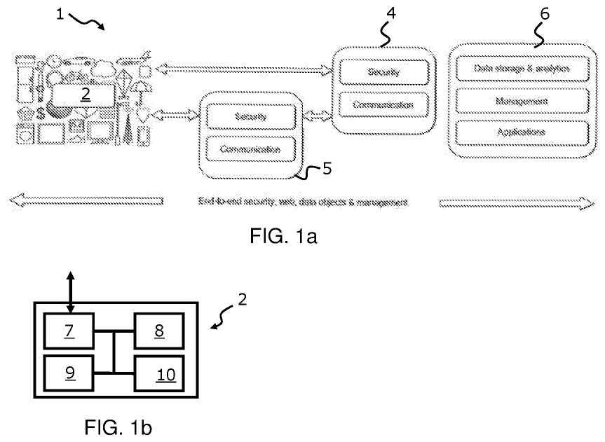

FIG. 1a shows a deployment scenario for a plurality of devices requiring access to one or more services according to an embodiment;

FIG. 1b shows a schematic illustration of a device of FIG. 1a according to an embodiment;

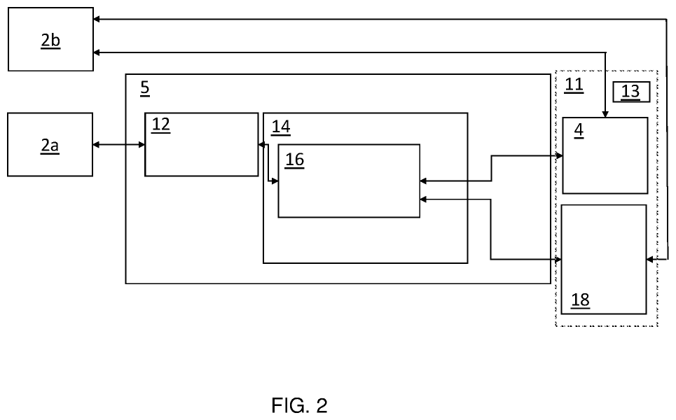

FIG. 2 depicts an illustrative example of devices in communication with an intermediary apparatus and a device management platform;

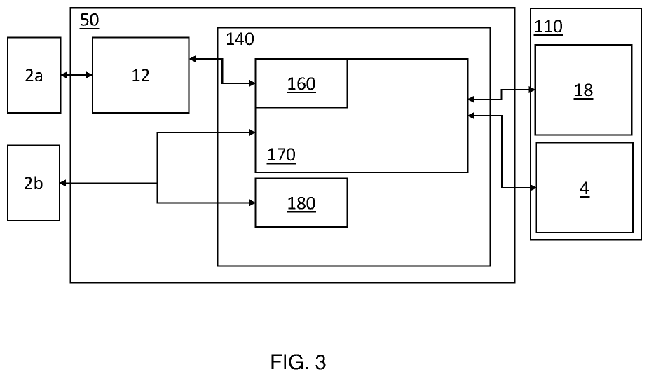

FIG. 3 depicts an illustrative example of devices in communication with an intermediary apparatus in accordance with an embodiment;

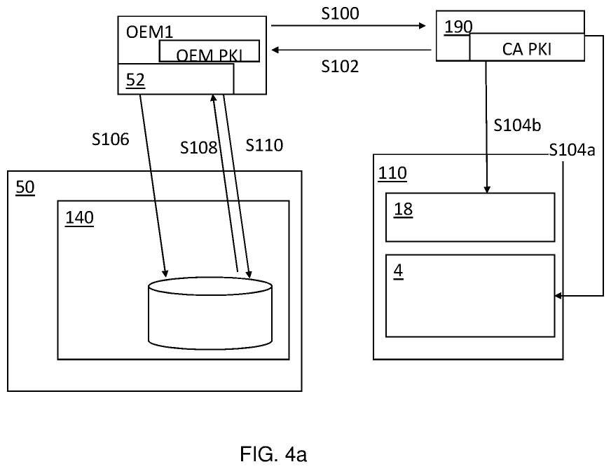

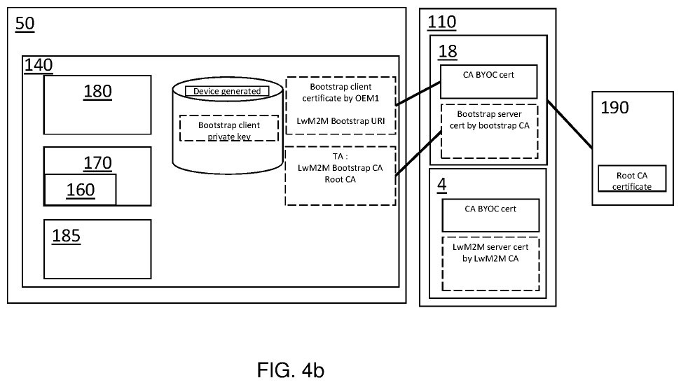

FIG. 4a illustratively shows an example provisioning process by a first party to setup an intermediary apparatus;

FIG. 4b illustratively shows the intermediary apparatus of FIG. 4a in an initial state;

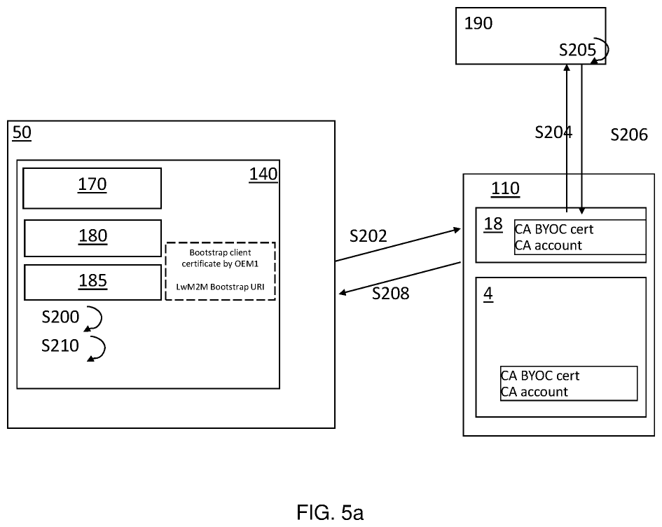

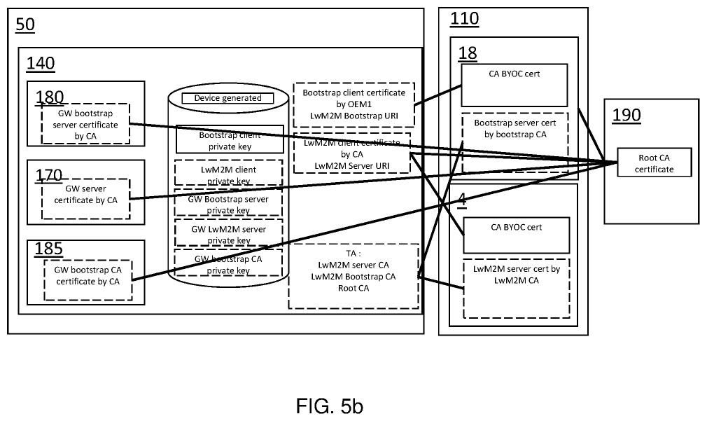

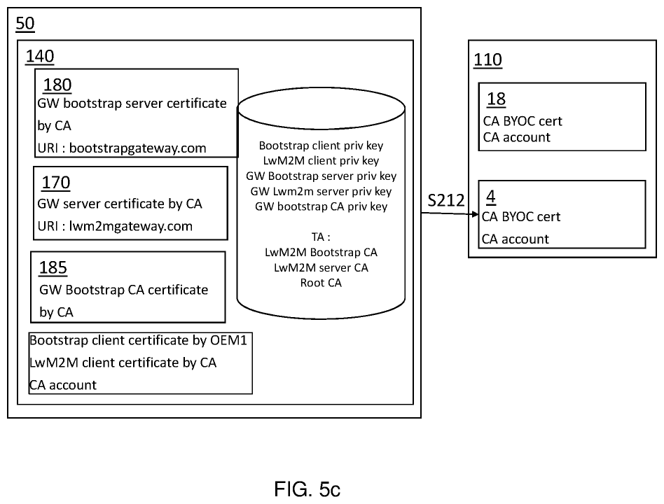

FIG. 5a illustratively shows an example of a bootstrap process by the intermediary apparatus of FIG. 4a with a bootstrap server;

FIG. 5b illustratively shows the intermediary apparatus in a bootstrapped state following the bootstrap process of FIG. 5a;

FIG. 5c illustratively shows the intermediary apparatus registering with a resource server;

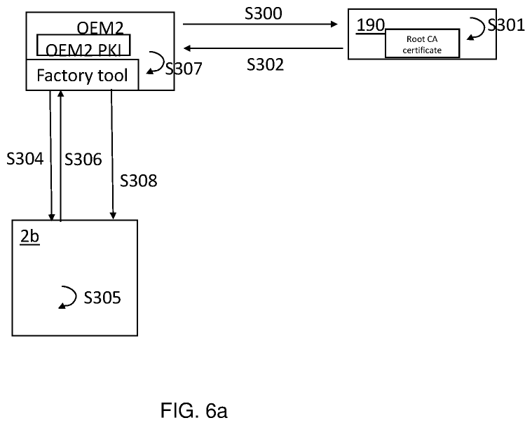

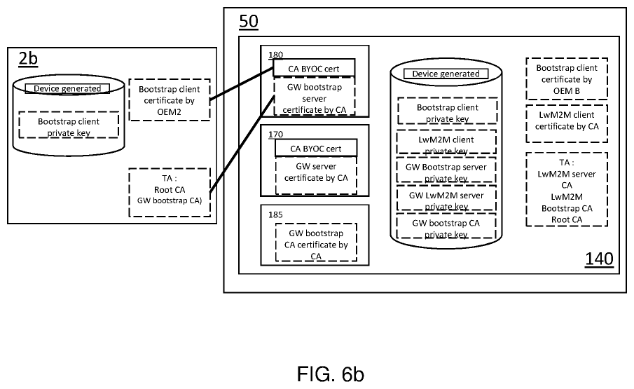

FIG. 6a illustratively shows an example provisioning process by a second party to setup a device;

FIG. 6b illustratively shows the device in an initial state after setup;

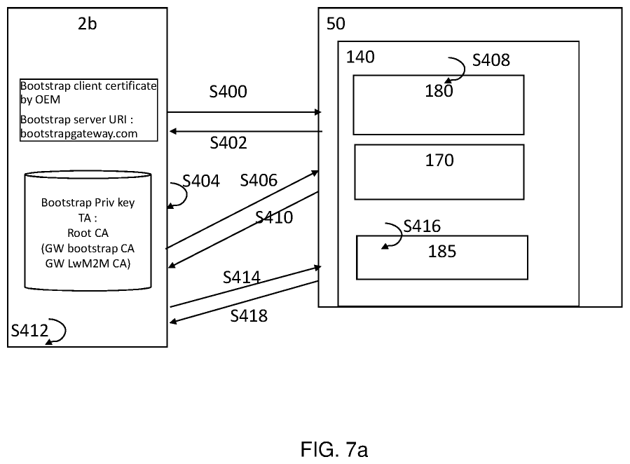

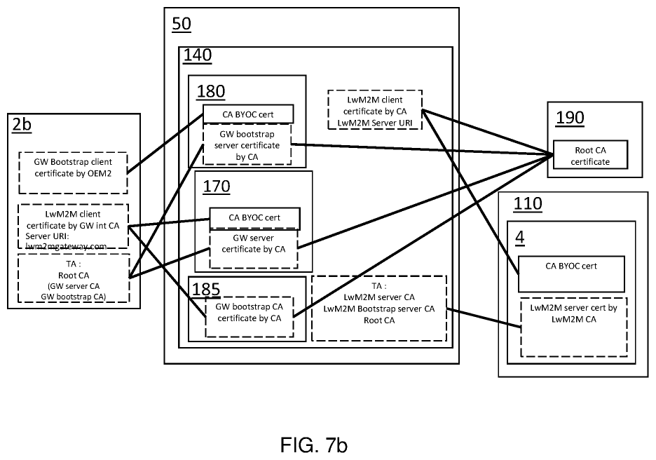

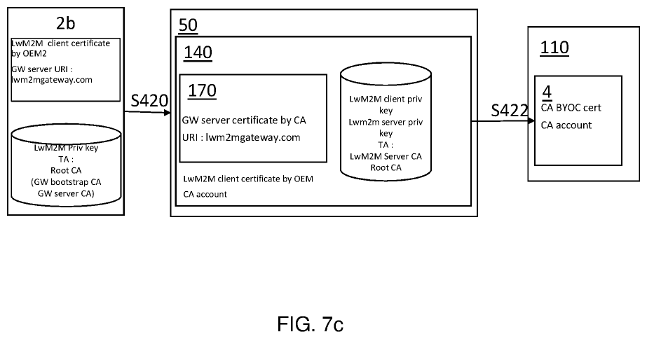

FIG. 7a illustratively shows an example of a bootstrap process by the device of FIG. 6a with a bootstrap server of the intermediary apparatus of FIG. 5b;

FIG. 7b illustratively shows the device of FIG. 7a in a bootstrapped state following the bootstrap process with the bootstrap server of FIG. 7a;

FIG. 7c illustratively shows the intermediary apparatus of FIG. 7a on-boarding the device to a device management platform; and

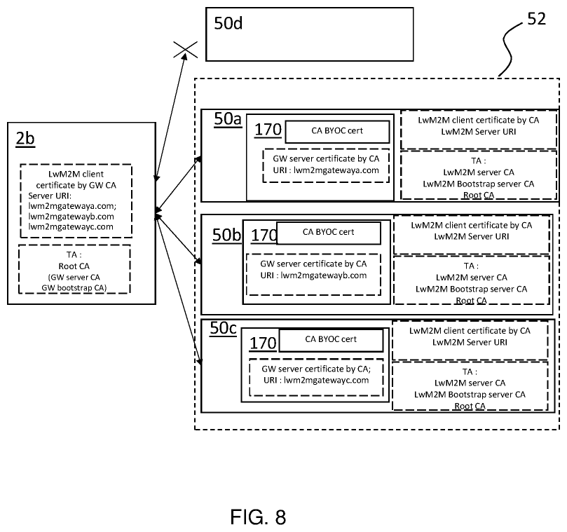

FIG. 8 illustratively shows a device communicating with a plurality of intermediary apparatuses.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter.

A network, such as an Internet of Things (IoT) network, may comprise multiple connected resources such as devices, apparatuses (e.g. gateways, servers) and services with different functionalities. The resources may be provided by different parties, (e.g. original equipment manufacturers (OEMs)/owners/manufacturers etc).

The IPv6 over Low Power Wireless Standard (6LoWPAN) is a set of standards which enable the efficient use of IPv6 over low-power, low-rate wireless networks on devices through an adaption layer and the optimization of related protocols.

The Open Mobile Alliance's LwM2M standard (i.e. ‘lightweight Machine-to-Machine’) is applicable to 6LoWPAN whereby a LwM2M bootstrap process is used to provide mandatory information (e.g. credential data) through a bootstrap interface for devices so that the devices can perform authentication (e.g. establish secure communications, register, enroll etc.) with one or more servers, whereby authentication assigns a device to a server to access one or more services (e.g. applications, databases etc.).

Traditional bootstrapping processes are used to provision devices, apparatuses and services with data to enable the devices, which are typically resource-constrained with limited power supply, communication capability, CPU performance and memory, to authenticate with the apparatuses and access one or more services.

Such authentication generally involves sharing or exposing sensitive credential data (e.g. cryptographic keys (e.g. private keys), certificates) to establish secure communications.

Broadly speaking, embodiments of the present techniques provide for establishing a chain of trust between a device and other resources across one more networks.

FIG. 1a shows a deployment scenario 1 for a device 2 operable to access one or more services 6, and FIG. 1b illustrates a device 2 according to an example.

Device 2 may be a computer terminal, a laptop, a tablet or mobile-phone, or may, for example, be a lightweight machine to machine (LwM2M) device used to turn objects into “smart-objects” such as streetlights, electric meters, temperature sensors and building automation as part of the IoT, and a range of market segments in which device 2 may be used is illustratively depicted in FIG. 1a. It will be appreciated that the examples of market segments in FIG. 1a are for illustrative purposes only and the claims are not limited in this respect.

Referring to FIG. 1b, the device 2 comprises communication circuitry 7 for communicating with a remote resource (e.g. an LwM2M server).

The communication circuitry 7 may use wireless communication, such as communication using wireless local area network (Wi-Fi), short range communication such as radio frequency communication (RFID) or near field communication (NFC), or communications used in wireless technologies such as ZigBee, Thread, Bluetooth, Bluetooth LE, IPv6 over Low Power Wireless Standard (6LoWPAN) or Constrained Application Protocol (CoAP). Also, the communication circuitry may use a cellular network such as 3G or 4G. The communication circuitry 7 may also use wired communication such as using a fibre optic or metal cable. The communication circuitry 7 could also use two or more different forms of communication, such as several of the examples given above in combination.

The device 2 further comprises processing circuitry 8 for controlling various processing operations performed by the device 2.

The device 2 may further comprise input/output (I/O) circuitry 9, such that the device 2 can receive inputs (e.g. user inputs, sensor inputs, measurement inputs etc.) and or generate outputs (e.g. audio/visual/control commands etc.).

The device 2 further comprises storage circuitry 10 for storing data, such as credential data, whereby the storage circuitry 10 may comprise volatile and/or non-volatile memory.

Such credential data may include one or more of: certificates, cryptographic keys (e.g. shared symmetric keys, public keys, private keys), identifiers (e.g. direct or indirect identifiers) etc.) whereby such credential data may be used by the device to authenticate with one or more remote resources (e.g. a bootstrap server/resource server). The credential data may also comprise one or more trust anchors which represent an authoritative entity. In embodiments, a public key of the trust anchor is used to verify a digital signature(s), and the trust anchor may comprise further associated data to constrain the types of information for which the trust anchor is authoritative. In embodiments, a device may use a trust anchor to determine whether a digitally signed object from another resource is valid by verifying a digital signature using the trust anchor's public key, and by enforcing the constraints expressed in the associated data for the trust anchor.

In the present figures, resource 4 is depicted as resource server 4 which may be part of, or interface with one or more public networks (e.g. the internet) and/or private networks enabling deployment of services in a secure manner from a private server, private cloud or public cloud environment. In embodiments the resource server may be part of a device management platform.

The resource server 4 may comprise hardware/software capable of providing server functionality, for example to provide access to a service 6 with which it interfaces or hosts, whereby such services may include one or more of: web service(s); data storage & analytics service(s), management service(s) and application service(s), although this list is not exhaustive.

The resource server 4 is depicted in the figures as a lightweight machine-to-machine (LwM2M) server, although the claims are not limited in this respect.

In embodiments, when device 2 cannot communicate directly with resource server 4, one or more intermediary apparatuses 5 may be provided, through which the device 2 can communicate with the resource server 4.

Device 2 may communicate with resource server 4, directly or via intermediary apparatus 5, using appropriate standards or protocols, whereby credential data on the device 2 may be used as an input to a security protocol to establish a secure communications channel with a remote resource. Such a security protocol may, for example, comprise Transport Layer Security/Datagram Transport Layer Security (TLS/DTLS), whereby TLS/DTLS is used to provide a secure channel between the device 2 and a remote resource, whereby TLS/DTLS security modes include both pre-shared key and public key technology, whereby such keys may be included in credential data provisioned on the device. The data (e.g. device data) protected by TLS/DTLS may be encoded as plain text, binary TLV, JSON, CBOR, or any other data exchange formats.

FIG. 2 depicts an illustrative example of an intermediary apparatus 5 which relays communications between a legacy device 2a and a resource server 4, whereby legacy device communicates with intermediary apparatus 5 using a first communications protocol e.g. BLE, whereby intermediary apparatus 5 may comprise a gateway apparatus (hereafter “gateway”).

In accordance with the present disclosure, a device which requires its messages to be translated for communication with another resource (e.g. LwM2M server) is referred to as a “legacy device”, while a device which does not require its messages to be translated for communication with another resource is referred to as a “supported device”.

Gateway 5 comprises a protocol translator 12 which converts messages of a first protocol from device 2a to messages of one or more supported protocol which can be processed by devices/apparatuses within and/or on the other side of the gateway.

As an illustrative example, the protocol translator 12 may translate a BLE message that uses a remote procedure call (RPC) mechanism from the device 2a to a RESTful message for LwM2M server 4. Similarly, a message from the LwM2M server 4 may be translated to a corresponding BLE message for the BLE device 2a.

It will be appreciated that the protocol translator 12 is not limited to translating BLE messages but may translate messages of any communications protocol to one or more supported protocols which can be processed by devices/apparatuses within and/or on the other side of the gateway 5. As a further illustrative example, the device 2a may use Device Language Message Specification (DLMS), whereby messages received at the protocol translator 12 are translated to a supported protocol for the LwM2M server 4.

Gateway 5 further includes an edge apparatus 14 (hereafter “GW edge”), whereby the GW edge 14 further comprises an edge service 16 which functions as a relay to transfer messages between the protocol translator 12 and LwM2M server 4.

In the embodiment depicted in FIG. 2, supported device 2b or the GW edge 14 may establish secure communications with the device 2a and/or LwM2M server 4 using cryptographic keys (e.g. asymmetric key-pair) provisioned thereon. The GW edge 14 may also communicate with a bootstrap server 18, which may engage in a bootstrap process with the edge server 14 to provision data thereon.

As depicted in FIG. 2, device 2b is a supported device and is provided with credential data to enable it to communicate directly with LwM2M server 4 and bootstrap server 18.

It will be seen therefore that the arrangement depicted in FIG. 2 does not provide local control by gateway 5 for supported device 2b. Instead the device must connect directly to the LwM2M server 4 and bootstrap server 18.

Furthermore, LwM2M server 4 may be a resource on a device management platform 11, which may be a cloud platform (e.g. where the device management platform is hosted on public or private cloud infrastructure).

The owner or administrator of device management platform 11 may also own/administrator various resources (e.g. device 2a, device 2b, gateway 5) and may store private keys for each of the respective resources in storage 13 on a server e.g. at the device management platform, and may provision private keys on devices using bootstrap server 18.

As a device must connect to device management platform 11 to obtain private keys, such functionality may result in the private keys being exposed to/accessed by a malicious or rogue party and increase the likelihood of the rogue party engaging in an attack on the device/gateway/device management platform (e.g. denial of service DoS attack; or act as a trusted device).

FIG. 3 illustratively shows an example of an intermediary apparatus 50 which legacy device 2a communicates with using a first communications protocol and which supported device 2b communicates using the first or a supported protocol.

The intermediary apparatus 50 depicted in FIG. 3 is a gateway, which comprises processing circuitry, storage circuitry and communication circuitry to communicate with one or more resources.

Gateway 50 comprises a protocol translator 12 which converts messages of the first protocol from legacy device 2a to a supported protocol which can be processed by devices/apparatuses within and/or on the other side of the gateway 50.

Gateway 50 further includes an edge apparatus 140 (hereafter “GW edge”) whereby the GW edge 140 further comprises a server 170, which is hereafter referred to as a gateway (GW) server or edge server, whereby GW server 170 functions as a relay to transfer unsupported messages between the device 2a/2b and LwM2M server 4. In some embodiments the GW server 170 comprises GW service 160 as described above, whereby GW service 160 may provide the functionality of a protocol translator for legacy devices. GW server 170 is further configured to receive messages in a supported protocol from a supported device 2b.

Gateway 50 further includes a gateway (GW) bootstrap server 180, which may perform a bootstrap process with supported device 2b to provision data (e.g. credential data) thereon. Messages from/to a legacy device 2a may be translated by protocol translator so the bootstrap server 180 can perform a bootstrap process with a legacy device 2a to provision data (e.g. credential data) thereon.

As described above, providing a gateway 50 having a service 160 and GW server 170 means both legacy devices 2a and supported devices 2b can communicate with the LwM2M server 4 via the gateway 50.

Further, providing the GW bootstrap server 180 on the gateway means that supported devices 2b can be bootstrapped locally using credential data, such that there is no requirement for the devices to connect to a remote bootstrap server.

As will be described below, a chain of trust between the device 2b and the LwM2M server 4 is established using credential data provisioned in storage on the device 2b (hereafter “device credential data”) and credential data provisioned on the gateway 50 (hereafter “gateway (GW) credential data”), while reducing the likelihood of exposure of sensitive credential data (e.g. private keys).

As described above, different resources may be owned or managed/administrated by different parties, and each party may require different data (e.g. credential data/application data) on those resources, to enable the resources to communicate with other resources. In the illustrative examples of FIGS. 4a and 4b, the gateway 50 is owned by a first party (hereafter OEM 1), whereby OEM 1 provisions various data on gateway 50 to enable it to communicate with one or more resources.

In embodiments LwM2M server 4 may be a resource on a device management platform 110, which may be a cloud platform (e.g. where the device management platform is hosted on public or private cloud infrastructure). It will be appreciated that the device management platform 110 is not limited to being a cloud platform and may comprise a private platform (e.g. where the device management platform is hosted on a private or on-premise infrastructure); and a hybrid platform (e.g. a combination of the public and private platforms).

In embodiments a resource owner may have an associated account at the device management platform 110, the account having, for example, credential data associated with that owner (e.g. an account ID, one or more certificates and/or trust anchors, one or more associated cryptographic keys (e.g. public key) etc.).

FIG. 4a illustratively shows an example process of provisioning gateway 50 by OEM1 to setup gateway 50 using a factory tool 52. Factory tool 52 may comprise one or more provisioning servers and/or may comprise providing a smartcard on the gateway 50 during a factory setup process, for example. FIG. 4b depicts the gateway 50 in an initial state after setup.

At S100 OEM1 issues a certificate signing request (CSR) and transmits it to a root authority 190, depicted as a certificate authority (CA) or root CA, such as VeriSign, GlobalSign or the like, whereby the CSR may specify information such as one or more of: an identifier for OEM1; address identifiers for one or more devices/apparatuses (e.g. an LwM2M bootstrap server 18 and LwM2M server which gateway 50 should authenticate with); and the CSR may include a public key of OEM1, whereby a corresponding private key is securely stored at a public key infrastructure (PKI) server of OEM1. Such public and private keys may be generated using OEM1's PKI server.

At S102 the root CA 190 issues an OEM1 CA certificate to the OEM1, whereby the OEM1 CA certificate is derived from a root CA certificate at PKI of the root CA 190. For example, the root CA 190 may sign the OEM1 public key in the CSR with a private key of the root CA certificate to generate the OEM1 CA certificate.

As such, OEM1 CA certificate has a chain of trust to the root CA (whereby the chain of trust is to the CA certificate of the root CA), and enables OEM1 to act as an intermediate CA, with any certificates derived from the OEM1 CA certificate also having a chain of trust to root CA certificate.

At S104a and S104b root CA 190 also issues a trust anchor derived from the root CA certificate to both the LwM2M bootstrap server 18 and LwM2M server 4, whereby bootstrap server 18 and LwM2M server are depicted as part of device management platform 110.

In embodiments the trust anchors provisioned to the LwM2M bootstrap server 18 and LwM2M server 4 may be linked to a particular account (e.g. as specified by OEM1, or by the root CA).

In embodiments such a trust anchor is a trust anchor certificate generated by a root CA or an intermediate CA as part of a bring-your-own-certificate (BYOC) process (hereafter referred to as ‘CA BYOC certificate’).

The CA BYOC certificates are each are derived from root CA certificate thereby enabling the respective resources 4/18 to verify that a certificate presented by a different resource has a chain of trust to root CA certificate.

At S106 OEM1 configures the bootstrap identifier (e.g. URI) to point to the LwM2M bootstrap server 18 and requests the gateway 50 to generate a CSR.

At S106 OEM1 provisions trust anchors (TA) comprising: LwM2M bootstrap CA trust anchor and root CA trust anchor on the gateway 50. As will be appreciated, the LwM2M bootstrap CA trust anchor and root CA trust anchor will enable the gateway 50 to verify that a certificate presented by LwM2M bootstrap server 18 can be trusted (e.g. by verifying the chain of trust to the root CA certificate).

At S108 the gateway 50 transmits a CSR to OEM1, whereby the gateway 50 generates and transmits a bootstrap client public key as part of the CSR and generates and stores a corresponding bootstrap client private key in storage.

At S110 the OEM1 provisions a bootstrap client certificate on the gateway 50 in response to the CSR (e.g. by signing the public key in the CSR with the OEM1 private key). The LwM2M bootstrap server 18 can verify the bootstrap client certificate when presented thereto using the CA BYOC certificate.

As depicted in FIG. 4b, when the gateway 50 is setup by the OEM1, the gateway 50 comprises a GW server 170 comprising service 160, GW bootstrap server 180 and further comprises a gateway (GW) intermediate CA 185, which can be used by the gateway 50 to generate certificates providing a chain of trust to a root certificate as will be described below.

The gateway 50 further comprises GW credential data to authenticate with other resources, whereby in the present illustrative example the GW credential data comprises the bootstrap client private key, the bootstrap client certificate by OEM1 (e.g. having an identifier for LwM2M bootstrap server (e.g. a URI)). The GW credential data further comprises a trust anchor comprising: LwM2M bootstrap CA trust anchor and root CA trust anchor to enable the gateway 50 to determine whether credential data (e.g. a certificate) presented thereto by the LwM2M bootstrap server can be trusted (e.g. having a chain of trust to the root CA).

The credential data on the LwM2M bootstrap server 18 of FIG. 4b (hereafter bootstrap credential data) is depicted as having the CA BYOC certificate and LwM2M bootstrap certificate issued by a bootstrap CA. The LwM2M server 4 is also depicted as having credential data (hereafter “LwM2M server credential data”) comprising the CA BYOC certificate and a LwM2M server certificate issued by a LwM2M server CA.

The gateway 50 can then initiate a bootstrap process with LwM2M bootstrap server 18 using the bootstrap client certificate provisioned thereon, which the LwM2M bootstrap server 18 can verify is trusted using the CA BYOC certificate.

Similarly, the gateway 50 can verify bootstrap credential data received from the LwM2M bootstrap server 18 with the trust anchors provisioned thereon.

FIG. 5a illustratively shows an example of a bootstrap process by the gateway 50 with bootstrap server 18. FIG. 5b depicts the gateway 50 in a bootstrapped state following the bootstrap process with bootstrap server 18.

At S200 the gateway 50 generates a plurality of CSRs to obtain certificates for various resources and generates a public/private key pair for each CSR, with the respective private keys stored in storage on the gateway 50 and the respective public keys included in the respective CSRs. The CSRs generated at S200 are for the gateway 50 as LwM2M client; the GW server 170; the GW bootstrap server 18 and GW intermediate CA 185.

At S202 the gateway 50 initiates a bootstrap process with bootstrap server 18 using the bootstrap client certificate and transmits the CSRs to bootstrap server 18.

At S204, the bootstrap server 18 transmits the CSRs to the root CA 190, and at S205 the root CA 190 processes the CSRs (e.g. signs the public keys of the respective CSRs with a private key for the root CA certificate) and at S206 transmits a LwM2M client certificate, a GW LwM2M server certificate, a GW bootstrap server certificate and a GW bootstrap intermediate CA certificate.

At S208, the bootstrap server 18 provisions the various certificates from the root CA 190 on the gateway 50 and also provisions a trust anchor for the LwM2M server CA, to enable the gateway 50 to verify server credential data presented by the LwM2M server.

At S210 the respective certificates are configured by the gateway 50 to enable other resources authenticate with the gateway 50 using their own respective credential data. For example, identifiers (e.g. URIs) are configured for the respective resources.

The chain of trust between the different credential data (e.g. device credential data; GW credential data; bootstrap credential data; server credential data etc.) following bootstrap of the gateway 50 is depicted in FIG. 5b, whereby as illustratively shown the GW server 170 comprises GW server credential data comprising an associated GW server certificate having a URI (depicted as ‘lwm2mgateway.com’ in FIG. 5c), whereby the GW server certificate has chain of trust to the root CA certificate; the GW bootstrap server 180 comprises GW bootstrap credential data comprising a GW bootstrap server certificate having a URI (depicted as ‘bootstrapgateway.com’ in FIG. 5c), whereby the GW bootstrap server certificate has chain of trust to the root CA certificate; and the GW intermediate CA 185 comprises GW intermediated credential data comprising a GW bootstrap CA certificate issued by root CA 190, having a chain of trust to the root CA certificate, from which the gateway 50 can function as an intermediate CA to generate further certificates for resources which authenticate therewith, such further certificates having a chain of trust to the root CA certificate.

The GW credential data further comprises a LwM2M client certificate for use in authenticating with LwM2M server 4 (e.g. encrypting communications with a public key therein), the LwM2M client certificate having a chain of trust to the CA BYOC certificate on the LwM2M server 4 and to the root CA certificate.

Furthermore, the GW credential data comprises the bootstrap client private key from the initial setup, and further comprises the private keys corresponding to the public keys in the respective CSR requests generated at S200, whereby the private keys may be used to authenticate with the respective resources (e.g. encrypt communication, provide end-to-end communications etc.).

As depicted in FIG. 5c, at S212 the gateway 50 registers as a gateway with LwM2M server 4 using GW credential data comprising the LwM2M client certificate, whereby the LwM2M server 4 can verify the LwM2M client certificate using the CA BYOC certificate. Similarly, the gateway 50 can verify communications from LwM2M server 4 using trust anchors thereon. When verified, the gateway 50 is “on-boarded” to the device management platform 110.

As such, even though the gateway 50 and LwM2M server 4 may be owned by different parties (OEM 1, Arm®, Google®, Intel®, Azure®), while the software and credential data on those resources (e.g. device credential data; GW credential data; server credential data) may be owned by another party (e.g. the root CA), the gateway 50 can still be verified and on-boarded to the device management platform 110.

The LwM2M server 4 may also provision the GW credential data on the gateway 50 and/or configure GW credential data on the gateway.

As described above, different parties may own different resources and FIG. 6a illustratively depicts device 2b being owned by OEM2, and further illustratively shows an example provisioning process by the OEM2 to setup device 2b (e.g. using a factory bootstrap server) to enable it to bootstrap with a gateway 50 (not shown in FIG. 6a or 6b).

FIG. 6b depicts the device 2b in an initial state after setup, and further depicts the chain of trust between the device credential data on the device 2b and the GW credential data on the gateway 50.

At S300 OEM2 issues a CSR and transmits it to root CA 190 whereby the CSR may specify information such as one or more of: an identifier for OEM2; address identifiers for one or more devices/apparatuses and the CSR may include a public key of OEM2, whereby a corresponding private key is securely stored at PKI server of OEM2. Such public and private keys may be generated using OEM2's PKI server.

At S301 the root CA 190 processes the CSR and at S302 issues OEM2 CA certificate to the OEM2, whereby the OEM2 CA certificate is derived from the root CA certificate.

As such, OEM2 CA certificate has a chain of trust to the root CA certificate, and enables OEM2 to act as an intermediate CA, with any certificates derived from the OEM2 CA certificate having a chain of trust to root CA certificate.

At S304 OEM2 provisions a trust anchor comprising a GW bootstrap server CA trust anchor and root CA trust anchor. OEM2 also configures the bootstrap identifier for the bootstrap server with which the device 2b is to authenticate with (e.g. URI: bootstrapgateway.com). OEM2 also requests the device 2b to generate a CSR.

At S305, the device 2b generates a CSR for the bootstrap client at the URI, and generates a public and private key pair for the CSR, and at S306 the device 2b transmits the CSR to OEM2, whereby the device 2b transmits the bootstrap client public key as part of the CSR and generates and stores the corresponding bootstrap client private key in storage.

At S307, OEM2 processes the CSR and at S308 the OEM2, as intermediate CA, provides a bootstrap client certificate to the device 2b in response to the CSR (e.g. by signing the public key in the CSR with the OEM2 private key corresponding to the OEM2 CA certificate), whereby the bootstrap client certificate has a verifiable chain of trust to the root CA certificate because it has been signed by the intermediate CA. Therefore, the GW bootstrap server 180 can verify the bootstrap client certificate when presented thereto using the CA BYOC certificate.

As depicted in FIG. 6b, when the device 2b is setup by the OEM2, the device 2b comprises device credential data to authenticate with other resources, whereby in the present illustrative example the device credential data comprises the bootstrap client certificate by OEM2 and the bootstrap client private key generated by the device 2b.

The device credential data on device 2b further comprises a trust anchor comprising: GW bootstrap CA trust anchor and root CA trust anchor to verify GW credential data presented by GW bootstrap server 180.

The GW bootstrap server 180 is depicted as having GW bootstrap credential data comprising the CA BYOC certificate and a GW bootstrap certificate by the CA. The GW server 170 is also depicted as having GW server credential data comprising a CA BYOC certificate and the GW server certificate by the CA. The CA BYOC certificate at the GW bootstrap server 180 and GW server may be provisioned by GW intermediate CA 185 or may be provisioned during a registration process with LwM2M server 4.

The device 2b can then initiate a bootstrap process with GW bootstrap server 180 using the bootstrap client certificate by OEM2 thereon, and verifying the GW credential data presented by the GW bootstrap server 180 using the trust anchors provisioned thereon.

FIG. 7a illustratively shows an example of a bootstrap process by the device 2b with GW bootstrap server 180; and FIG. 7b illustratively shows the device 2b in a bootstrapped state following the bootstrap process.

At S400, the device 2b initiates a bootstrap process with GW bootstrap server 180.

At S402, the bootstrap server presents the GW bootstrap server certificate to device 2b (e.g. by signing communications with the private key corresponding to the public key therein).

At S404, the device 2b verifies the bootstrap server certificate, for example using the trust anchor(s) provisioned thereon.

At S406, the device 2b provides the bootstrap client certificate to the GW bootstrap server 180 (e.g. by signing communications with the private key corresponding to the public key therein), whereby at S408 the GW bootstrap server 180 verifies the bootstrap client certificate using the trust anchors provisioned thereon.

At S410, when the bootstrap client certificate is verified, the GW bootstrap server 180 bootstraps the device 2b and requests the device 2b to generate a CSR request for the device 2b as an LwM2M client.

At S412 the device 2b generates the CSR and further generates a public/private key pair for the CSR, and at S414 transmits the CSR with the public key included therein.

At S416, the GW intermediate CA 185 processes the CSR to generate device credential data comprising, for example, a LwM2M client certificate (e.g. by signing the public key of the CSR with a private key for the GW bootstrap intermediate CA certificate) and at S418 the GW provisions device credential data on the device 2b, the device credential data comprising the LwM2M client certificate and an identifier (e.g. URI) for the GW server 170, whereby the device 2b will authenticate using the LwM2M client certificate. The device credential data may further include a trust anchor for the GW LwM2M server CA, to enable the device 2b to verify GW credential data (e.g. a GW server certificate) presented by the GW LwM2M server.

When the device is not capable of generating public/private key pairs for the CSR at S412, the device credential data comprising, for example, the LwM2M client certificate and an identifier (e.g. URIs) for the GW server 170, the private key corresponding to a public key in LwM2M client certificate; and trust anchor for the GW LwM2M server CA may be provisioned as part of the bootstrap process, whereby secure communications may have been established with GW bootstrap server 180 using the bootstrap private key to reduce exposure of any private key transmitted from the GW bootstrap server 180 to the device 2b.

As depicted in FIG. 7b, following the bootstrap process the device credential data further comprises LwM2M client certificate issued by the GW intermediate CA and having an associated identifier (e.g. URI) for the GW server 170 (depicted as lwm2mgateway.com) whereby the GW server 170 can verify the LwM2M client certificate using the CA BYOC cert.

The chain of trust between the credential data on the respective resources (e.g. device credential data, GW credential data, bootstrap credential data, and server credential data) is also depicted in FIG. 7b. For simplicity, the chain of trust for the bootstrap client certificate by OEM1 on gateway 50 is not shown in FIG. 7b, but this is shown in FIG. 4b above.

Using the device credential data provisioned thereon, the device 2b can then register with the LwM2M server via gateway as depicted in FIG. 7c, whereby at S420 the device 2b registers with the GW server 170 using the LwM2M client certificate by OEM2, whereby the GW server 170 can verify the LwM2M client certificate by OEM2 using the CA BYOC certificate, and at S422 the GW server 170 registers the device 2b with LwM2M server 4. The device may also verify GW credential data (e.g. a GW server certificate) presented by the GW server 170 using the trust anchors provisioned thereon.

As the GW server 180 is registered as a gateway with LwM2M server 4, the LwM2M server 4 trusts the device 2b, and the GW server 170 can function as a relay to transmit messages between LwM2M server 4 and device 2b.

As such, even though the device 2b and gateway 50 may be owned by different parties (OEM1 & OEM 2), while the software and credential data on those respective resources may be owned by another party (e.g. the root CA) and the device management platform may be owned by an even further party still (e.g. Arm®, Google®, Intel®, Azure® etc.), the device 2b can register with the gateway 50, and the gateway 50 can on-board the device 2b to the device management platform 110, whereby the resources rely on the established chain of trust between the respective credential data thereon.

Furthermore, any number of device(s), intermediary apparatus(es) or resource server(s) may be provisioned with credential data having a chain of trust to the root CA. The present techniques enable a first intermediary apparatus, such as a gateway, having an intermediate CA thereon to generate credential data (e.g. certificates, trust anchors) for devices and provision the credential data on the devices, to build a chain of trust from the devices to a root CA, such that the devices can be on-boarded to a device management system using inter alia the device credential data generated by the intermediate CA.

The first intermediary apparatus can then relay messages between the devices and one or more servers (e.g. LwM2M servers) on the device management platform.

In embodiments, after bootstrapping is complete, the devices having the device credential data with a chain of trust to the root CA can register with further intermediary apparatus(es) which trust the credential data provisioned by the first intermediary apparatus.

As depicted in FIG. 8, gateways 50a-c are depicted as having a relationship (depicted by the dotted box 52), whereby all gateways 50a-c are peer gateways. In the present illustrative example, gateway 50d has no relationship to gateways 50a-c, and is, therefore, not a peer of those gateways.

For example, gateways 50a-c may be owned by the same party, while gateway 50d may be owned by a different party; gateways 50a-c may be on-boarded to a different device management platform to which gateway 50d is on-boarded; or gateway 50d may be on-boarded to the same device management platform as gateways 50a-c but may not yet have been provisioned with the necessary credential data be able to onboard devices thereto.

In embodiments, when the device is bootstrapped by a bootstrap server on a gateway, the device may be provisioned with identifiers for one or more peer gateways of the gateway that performed bootstrapping. As depicted in FIG. 8, device 2b is provisioned with URIs for all peer gateways 50a-50c.

As such, as all peer gateways 50a-50c can verify that the credential data presented by the device 2b has a chain of trust to the root CA, the peer gateways can each on-board the device 2b to device management platform (not shown in FIG. 8) and/or relay messages between a server at the device management platform and the device 2b. For example, presenting the credentials may comprise signing messages using a private key corresponding to a public key in the LwM2M client certificate issued by the GW intermediate CA 185 and provisioned on the device during the bootstrap process.

A legacy device may also communicate with one or more of the gateways having a protocol translator (or server) to translate the communications therefrom.

Device 2b may not communicate with gateway 50d as it may not be provided with an identifier therefor. Nonetheless, if device does attempt to communicate with gateway 50d, gateway 50 would not be able to verify a chain of trust in the credential data presented thereto by the device 2b, so would not authenticate the device 2b.

As described above, the device management platform may be viewed as being located between the root CA and the intermediary apparatus, whereby the intermediary apparatus can on-board devices thereto, and relay messages between a server on the device management platform and the device on the basis of the chain of trust to the root CA. As will be appreciated, the device management platform 110 does not need to be an owner of the resources (e.g. intermediary apparatus or the device(s)), and is not required to store any private keys for the resources nor is it required to function as a root CA. Therefore, the present techniques reduce exposure of credential data to rogue parties.

As described above an intermediary device may comprise processor circuitry, storage circuitry and communication circuitry, whereby the processor circuitry may be embodied as any type of processor capable of performing the functions described herein. For example, the processor circuitry may be embodied as a single or multi-core processor(s), digital signal processor, microcontroller, or other processor or processing/controlling circuit. Similarly, the storage circuitry may be embodied as any type of volatile or non-volatile memory or data storage capable of performing the functions described herein. In operation, the storage circuitry may store various data and software used during operation thereof such as operating systems (e.g. Linux OS), applications, programs, libraries, and drivers. The storage circuitry may be communicatively coupled to the processor circuitry.

As will be appreciated, the servers described herein may be embodied as any type of server capable of performing the functions described herein, whereby the servers may include hardware and/or software components.

In a further related aspect, the present techniques provide a non-transitory data carrier carrying code which, when implemented on a processor, causes the processor to carry out the method described herein.

The techniques further provide processor control code to implement the above-described systems and methods, for example on a general purpose computer system or on a digital signal processor (DSP). The techniques also provides a carrier carrying processor control code to, when running, implement any of the above methods, in particular on a non-transitory data carrier—such as a disk, microprocessor, CD- or DVD-ROM, programmed memory such as read-only memory (firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended items.

1. A gateway (GW) apparatus for registering a device with a resource server, the GW apparatus comprising a GW server, the GW apparatus to:
receive gateway credential data having a verifiable chain of trust to a root authority to authenticate with the resource server;
receive, at the GW server, GW server credential data comprising a trust anchor to verify whether device credential data presented by the device has a chain of trust to the root authority and a GW server certificate comprising a verifiable chain of trust to the root authority to authenticate with the device;
authenticate, at the GW server, the device using the GW server credential data; and
in response to successful authentication of the device, register, using the GW server, the device with the resource server.

2. The apparatus of claim 1, wherein the GW server is to relay messages between the device and the resource server.

3. The apparatus of claim 1, comprising an intermediate certificate authority, the intermediate certificate authority to generate the device credential data.

4. The apparatus of claim 1, wherein the device credential data comprises a client certificate with which the device can authenticate with the GW server, wherein the client certificate comprises a chain of trust to the root authority.

5. The apparatus of claim 3, wherein the device credential data comprises a trust anchor with which the device can verify the credential data presented thereto from the GW server has a chain of trust to the root authority.

6. The apparatus of claim 1, to further store a bootstrap (BS) server to provision the device credential data on the device.

7. The apparatus of claim 6, wherein the BS server is to authenticate with the device using BS credential data, and wherein the BS credential data comprises a verifiable chain of trust to the root authority.

8. The apparatus of claim 1, further comprising a protocol translator to translate messages from a first protocol to a second protocol.

9. The apparatus of claim 8, wherein the protocol translator comprises a service at the GW server.

10. The apparatus of claim 1, wherein the trust anchor is to verify that device credential data presented by a further device has a chain of trust to the root authority.

11. The apparatus of claim 10, wherein the GW server is to authenticate with the further device using the GW server credential data.

12. The apparatus of claim 11, wherein the GW server is to register the further device with the resource server when the further device is authenticated.

13. The apparatus of claim 1, wherein the trust anchor comprises a trust anchor certificate.

14. The apparatus of claim 1, wherein the root authority comprises a root authority certificate.

15. A method of registering a device at a resource server, the method comprising:
receiving, at a gateway (GW) apparatus, GW credential data having a verifiable chain of trust to a root authority to authenticate with the resource server;
receiving, at the GW apparatus, GW server credential data comprising a trust anchor to verify whether device credential data presented by the device has a chain of trust to the root authority and a GW server certificate comprising a verifiable chain of trust to the root authority;
authenticating, at the GW apparatus, the device using the GW server credential data;
registering, using the GW apparatus, the device with the resource server in response to successful authentication of the device.

16. The method of claim 15, wherein authenticating the device comprises:
receiving, at the GW apparatus from the device, first device credential data;
verifying, using a first trust anchor at the GW apparatus, that the first device credential data has a chain of trust to the root authority;
generating, at the GW apparatus, second device credential data having a verifiable chain of trust to the root authority when the first device credential data is verified;
provisioning, on the device, the second device credential data.

17. The method of claim 16, further comprising:
verifying, using a second trust anchor at the GW apparatus, that the second device credential data has a chain of trust to the root authority;
registering the device with the resource server when the second device credential data is verified.

18. The method of claim 17, comprising:
relaying, using the GW apparatus, messages between the device and the resource server.

19. The method of claim 18 comprising:
translating, using the GW apparatus, the messages from a first protocol to a second protocol.

20. (canceled)

21. A system comprising:
a device to store device credential data;
a resource server;
a gateway (GW) apparatus to store:
gateway credential data comprising a verifiable chain of trust to a root authority to authenticate with the resource server;
the gateway apparatus having a GW server to store:
GW server credential data comprising a trust anchor to verify that device credential data presented by the device has a chain of trust to the root authority and a GW server certificate comprising a verifiable chain of trust to the root authority, wherein the GW server is to authenticate the device using the GW server credential data; and
wherein the GW server is to register the device with the resource server when the device is authenticated.

22. The system of claim 21, wherein the resource server is part of a device management platform.

23-29. (canceled)
